(19) United States
(12) Patent Application Publication
(10) Pub. No.: US 2013/0045540 A1
(43) Pub. Date: Feb. 21, 2013

(54) METHOD AND APPARATUS FOR CAPTURING AND RETESTING AN ONLINE TOC EXCURSION SAMPLE

(71) Applicants: Matthew Grant Collier, Loveland, CO (US); Robert Lee Garvin, Loveland, CO (US); Terry Gene Stange, Loveland, CO (US)

(72) Inventors: Matthew Grant Collier, Loveland, CO (US); Robert Lee Garvin, Loveland, CO (US); Terry Gene Stange, Loveland, CO (US)

(73) Assignee: Hach Company, Loveland, CO (US)

(21) Appl. No.: 13/588,755

(22) Filed: Aug. 17, 2012

Related U.S. Application Data
(60) Provisional application No. 61/525,530, filed on Aug. 19, 2011.

(51) Int. Cl. G01N 31/00; B01L 3/00

(52) U.S. Cl. 436/146; 422/556; 422/80

(57) ABSTRACT

An aspect provides an analyzer for validating a measurement of total organic carbon in a sample of water, including: one or more processors; and a memory storing program instructions including: instructions for measuring an amount of total organic carbon in a first sample of water using and obtaining a first measurement thereof; instructions for identifying a potential excursion event when an amount of total organic carbon in the first sample is above a predefined threshold; instructions for capturing a second sample of water in a bottle responsive to detecting the potential excursion event; instructions for introducing the second sample into a the analyzer; instructions for measuring an amount of total organic carbon in the second sample using the analyzer and obtaining a second measurement thereof; and instructions for comparing the first measurement and second measurement. Other aspects are described and claimed.

### CLAIM FOR PRIORITY

This application claims priority to U.S. Provisional Application No. 61/525,530, filed on Aug. 19, 2011 and entitled “METHOD AND APPARATUS FOR CAPTURING AND RETESTING AN ONLINE TOC EXCURSION SAMPLE”, which is incorporated by reference here in its entirety.

### BACKGROUND

Total organic carbon (TOC) is the amount of carbon bound in an organic compound. TOC, which is typically measured from part per trillion (ppt) to parts per million (ppm) of carbon, is often used as a non-specific indicator of water quality or cleanliness. That is, for higher numbers of TOC, the higher number of potential organic contaminants exist within the water, and the lower the TOC, the lower number of potential organic contaminants exist within the water.

All TOC analyzers have in common the purpose of oxidizing or decomposing organic contaminants within a water sample to create carbon dioxide (CO₂) and subsequent measurement of CO₂ using conductivity or NDIR detection methods. In the case of low TOC levels (ppt to low ppm), a conventional approach for determining the amount of TOC in a sample of water may include oxidizing the organic carbon to CO₂ using Ultraviolet (UV) light and measuring the conductivity of the water before and after this oxidizing step. The change in conductivity is then converted to a TOC value using various algorithms based on known conductance and temperature data for the conductive products.

There are many applications for instruments capable of measuring the amount of TOC in water. For example, in the pharmaceutical industry, it is important to have ultra low levels of TOC. Therefore, manufacturers regularly monitor the levels of TOC in the water used to produce the pharmaceuticals and/or clean the production equipment.

Ultra purified water systems are typically designed to continuously monitor conductivity (uS/cm) and TOC (ppbC) levels of the water produced by these systems. An example of a continuous online TOC analyzer is the ANATEL PAT700 TOC analyzer sold by Hach Company of Loveland, Colo. ANATEL is a registered trademark of Hach Company in the United States and other countries.

The existing ANATEL PAT700 TOC analyzer equipped with Onboard Automated Standards Introduction System (OASIS) allows calibration of the analyzer by drawing small aliquots from standards bottles inserted into the instrument. Grab samples from other parts of the water system also may be collected and manually inserted for testing using this analyzer. Standards or grab samples are drawn in through a needle to an internal oxidation cell where they are exposed to UV light and decomposed to carbon dioxide. A vent needle allows the water sample to be drawn into the analyzer (out of the bottle) without creating a vacuum inside the bottle.

In addition to acting as a sample inlet, OASIS can also act as a sample outlet, by drawing water from an online source and injecting into empty bottles installed in the analyzer, thus allowing for collection of a water sample from the process for testing at another (laboratory) location for confirmation. In this case, the existing OASIS analyzer can be configured to use an excursion capture and validation feature, enabling the analyzer to capture a water sample from the UPW system when a user-defined high TOC or conductivity alarm occurs during online monitoring. With this feature selected, the instrument will fill a plastic or glass bottle with excursion sample water essentially immediately following the alarm. The filling process uses water system line pressure to back flush and fill the bottle which is inserted into the system in an inverted (or substantially inverted) manner. The bottle, which contains a septum in the cap, is inserted into a bottle bay in an inverted fashion such that needles (water inlet/outlet (transmitting) needle and vent needle) pierce the septum.

In the event that the analyzer detects an excursion and/or potential condition that indicates that the conductivity, TOC or other parameter of water is outside an acceptable range, the analyzer activates alarms to notify the water or production facility. The analyzer also automatically collects a sample of water from the system.

The water sample can then be measured off-line. An off-line measurement typically involves transporting the sample of water collected from the ultra purified water systems of interest to a laboratory for analysis.

At least two potential issues arise when conducting such off-line testing. Firstly, the time at which the water sample is tested most likely will not align with occurrence of the real-time excursion originating within the ultra purified water system. For example, minutes, hours or even days could pass after the excursion occurred and the water sample was collected and before it is tested in the laboratory. At that point, the excursion may have disappeared and the water conditions may have returned to normal. This can result in questions about the accuracy and reliability of the monitoring system and/or lead to unresolved concerns regarding the water quality.

Secondly, collection of the sample may introduce additional contaminants to the water—either from contaminants residing in the collection vessel (typically a glass or plastic bottle) or from air-borne organic materials to which the water sample may be exposed during collection. For example, laboratory personnel may accidentally contact the water sample during collection and cause contamination. Such additional TOC contamination can be a few ppbC or it can be several hundred ppbC. In these situations, it is impossible to differentiate the actual TOC from the water system from the TOC contributed by subsequent sample contamination. If the measured TOC is too high (e.g., greater than 500 ppbC), the ultra purified water cannot be used for the production of pharmaceuticals and/or cleaning of such equipment.

Another potential issue with existing analyzers includes the inability to completely fill the collection bottle with water. Because the bottle does not completely fill with water, there may be an insufficient volume of water to properly test the sample.

### BRIEF SUMMARY

In order to overcome these problems, a bottle for use with a water analyzer is capable of completely being filled when the analyzer indicates that a potential excursion within a water system exists. In summary, one embodiment of the bottle includes a main bottle body, and a bottle cap attachable to the main bottle body wherein the bottle cap includes a main portion having an aperture therein, a septum sized to cover said aperture and fit within an interior cavity of the bottle cap, and a vent tube disposed within the interior cavity of the bottle cap.

The inclusion of the vent tube within the interior of the cavity of the bottle cap and/or the bottle allows the bottle to completely fill with water, particularly when the bottle is filled while it is inverted. The vent tube allows air within the bottle to escape while water is entering the bottle, thereby reducing the pressure within the bottle.

Also disclosed herein is an online method of validating whether the analyzer correctly determined an excursion. This online validation method provides its users with real-time information as to whether it is necessary to take corrective action for the water system or whether the initially detected excursion was an anomaly or false alarm.

A method of validating an excursion capture sample comprises: detecting an excursion event with an analyzer; capturing an excursion sample in an excursion capture bottle responsive to detecting the excursion event; reintroducing the excursion sample in the excursion capture bottle into a measurement chamber of the analyzer; and validating the excursion sample by analyzing the excursion sample in the measurement chamber.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates examples of excursion capture bottles.

FIG. 2 illustrates an example excursion capture bottle.

FIG. 3 illustrates an exploded view of an example excursion capture bottle.

FIG. 4 illustrates an example excursion capture bottle in a bottle bay of a TOC analyzer.

FIG. 5 illustrates example screen captures of an analyzer user interface.

FIG. 6 illustrates an example method of validating an excursion sample.

FIG. 7 illustrates example analyzer circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Reference throughout this specification to “excursion” means an unexpected change or perturbation from normal or typical TOC and/or conductivity values in a water system. Excursions may be caused by organic breakthroughs in the water system and most often cause a temporary increase (hours to days) in TOC or conductivity levels.

Reference throughout this specification to an “excursion sample” means a water sample collected during the event or occurrence of a water system TOC and/or conductivity excursion.

Reference throughout this specification to “real-time excursion” means the actual time during which a water system excursion event occurs or takes place.

Reference throughout this specification to “on-line” means a TOC analyzer or other water analytical instrument is directly connected to a water system allowing the analyzer to sample water from a side stream, branch, or “T”-fitting for the purpose of real-time water measurement. On-line measurements are often synonymous with process or in-process measurement.

Reference throughout this specification to “off-line” means a TOC analyzer or other analytical instrument that is physically separated from or not co-located with the water system. Off-line measurements are often synonymous with laboratory measurement.

Reference throughout this specification to a “septum” means a partition or membrane or sealing member. For example, in embodiments disclosed in this specification, a septum that seals a portion of a bottle is disclosed and partitions the interior of a bottle from the exterior of the bottle. In addition to the sealing function, a septum can be pierced (by a needle) to allow transfer of fluid between the interior and exterior of the bottle or vice versa.

Reference throughout this specification to “validate” or “validating” means to confirm, certify, substantiate or verify.

Furthermore, the described features, structures, or characteristics may be combined in any suitable manner in one or more embodiments. In the following description, numerous specific details are provided to give a thorough understanding of example embodiments. One skilled in the relevant art will recognize, however, that various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

In an existing system, for example an ANATEL PAT700 TOC analyzer, the vent needle does not allow the bottles to fill completely. Accordingly, an embodiment provides a vent drop tube or vent insert for the bottle in order to facilitate venting such that the bottle may be filled completely or substantially completely.

Additionally, an embodiment provides an automated process for testing the captured excursion samples in the same oxidation chamber of the analyzer, eliminating several potential error sources in such analyses. For example, once the sample is captured, the excursion sample may be re-drawn into the TOC analyzer and analyzed again for validation, using the same analysis or measurement chamber. If the TOC or conductivity results still exceed user-defined levels, the excursion sample has been validated and the user can feel confident the TOC analyzer has accurately measured the sample and the high results are not simply an instrument malfunction or the result of external contamination.

An embodiment provides for automatic collection (serial or parallel) of multiple excursion samples. For example, in addition to validating the excursion results via reintroduction and testing of the sample in the analyzer from an excursion bottle, the analyzer may capture other excursion sample(s) in other bottles and store the additional sample(s) for additional testing, such as off-line testing (in a laboratory), as needed. No additional external contamination is introduced into the first excursion sample reintroduced into the analyzer because the sample/instrument interface is never broken, eliminating the risk of exposing the sample to airborne organic contaminants.

An embodiment thus provides an analyzer that allows for the automatic capture of an excursion sample from a water system after exceeding a TOC or conductivity threshold, rather than being captured manually by trained personnel after an alarm condition. Moreover, an embodiment allows for the excursion bottles to be filled completely or substantially completely via inclusion of an additional venting feature. Additionally, an embodiment allows for more accurate off-line analysis by substantially eliminating the air space or “headspace” in the bottle. Eliminating the headspace prevents dissolved organic contaminants in the sample from portioning into the gas phase (evaporating into the air space above the liquid). Additionally, a method of automatically capturing a water sample during an excursion event eliminates the need for facility personnel to be available to troubleshoot the water system. With the sample captured, validated, re-validated (if needed or desired), and additional samples captured, users can wait to investigate these excursions when it is convenient rather than treating these situations as emergencies. Such real-time quality testing and response at the point of production builds quality into the process. Embodiments therefore also provide systems that enable easier compliance with regulatory agencies.

The description now turns to the Figures. It should be noted that the figures illustrate non-limiting example embodiments.

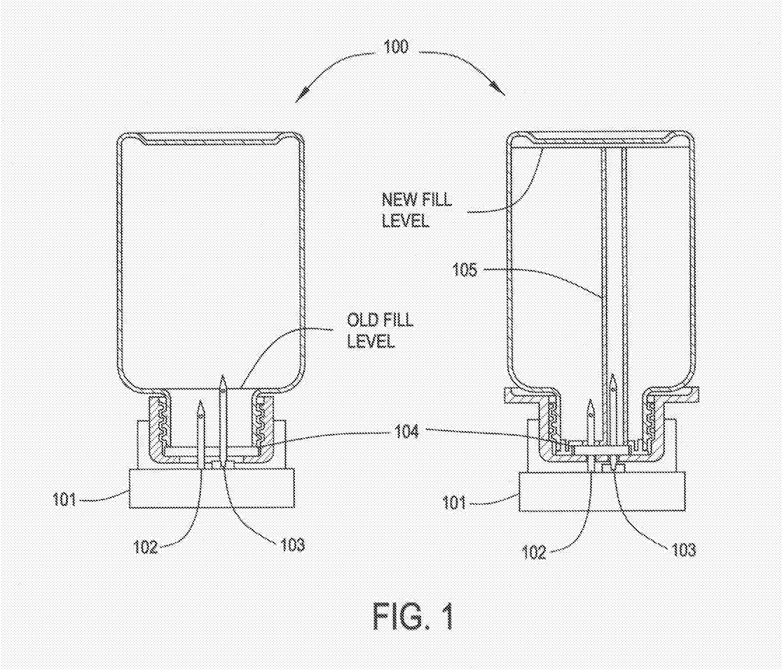

Referring to FIGS. 1(A-B) and 2(A-C), to allow a full bottle 100 of excursion water to be captured, the bottle cap 106 incorporates an internal vent drop tube or insert 105 (“vent tube”), effectively extending the vent needle 103 to the “top” of the bottle 100 (with the understanding that the inverted bottle “top” is the bottom of the bottle when positioned upright). This allows the bottle 100 to fill completely until reaching the level of the effective top of the vent needle 103, with the vent tube 105 providing that effective top, as illustrated in FIG. 1B. By comparison, FIG. 1A illustrates a bottle 100 lacking a vent tube 105. It should be noted throughout that although bottle 100 is referred to as an excursion capture bottle, it may serve other functions, such as a standards bottle, so long as the structure is commensurate with that described herein.

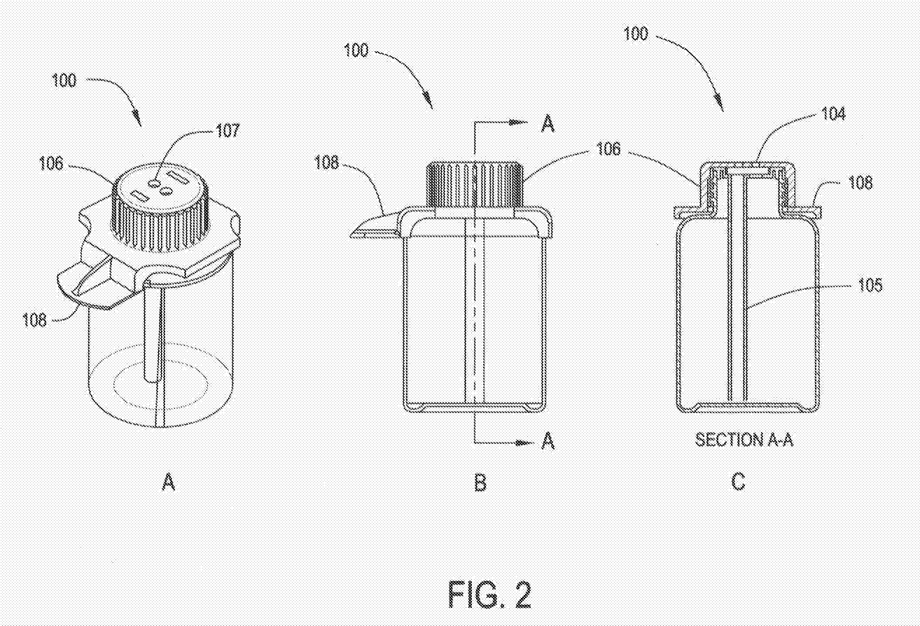

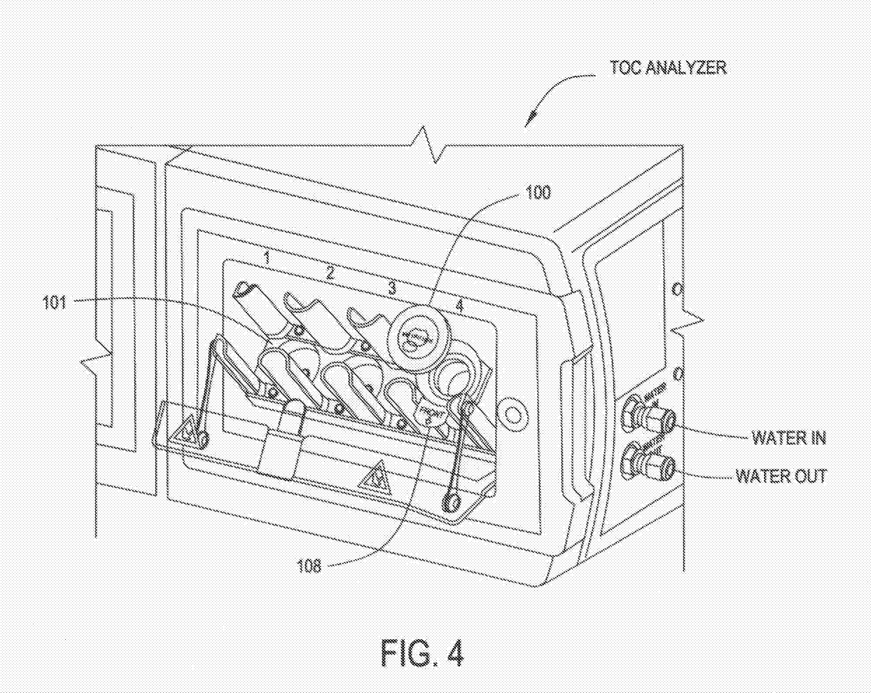

Additionally, the cap 106 structure may include various alignment and orientation tabs 108 to aid in alignment during insertion into the TOC analyzer (FIGS. 2 and 4). The cap 106 allows for complete bottle filling at specified water system flow rates, and provides a seal via septum 104.

As illustrated in FIG. 2(B-C), the vent tube 105 extends from the septum 104 to a position near the bottom of the bottle 100 (with the bottle in the upright position). Accordingly, when inverted and inserted into the TOC analyzer (FIG. 4), the inverted bottle is provided with a vent tube 106 that has one end sealing secured to the septum 104 and another end that permits air entry into the vent tube 106 at a position close to the bottle's 100 top (in the inverted position). This permits excursion fluid (for example, water having a TOC content that triggered an excursion sample collection) to fill the bottle to the level of the vent tube 106, that is, a substantially complete filling of the bottle 100.

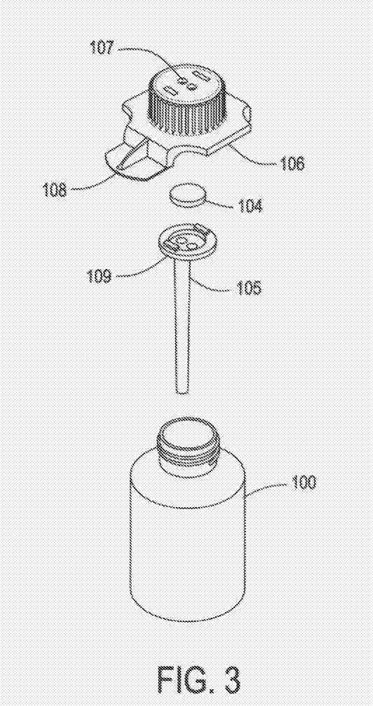

An exploded view is provided in FIG. 3. In the example of FIG. 3, the cap 106 contains needle holes or apertures (vent needle hole is specifically identified at 107) for ease of insertion of the liquid and vent transmitting needles (102, 103 respectively) of the TOC analyzer therein.

The cap 106 may also contain an alignment tab 108 to ensure that the bottle only fits into a corresponding bottle bay (101 of FIG. 1 and FIG. 4) of the TOC analyzer. Thus, the cap 106 may be provided with one or more alignment tabs 108 such that the bottle will only fit into the bottle bay 101 in the proper orientation. This also facilitates proper alignment of needles 102, 103 with their respective holes in the cap 106. Thus, the vent needle 103 will necessarily be aligned with the vent needle hole 107 of the cap 106 by virtue of the alignment tab 108 fitting into correspondingly shaped bottle bay 101 of the TOC analyzer.

Further illustrated in FIG. 3 is septum 104 and vent tube 105. Similar to cap 106 and alignment tab 108 thereof, the vent tube 105 may contain alignment tab(s) 109 to ensure that the vent tube 105 is properly aligned with vent needle hole 107 on assembly. The vent tube 105 may be fitted into place within an interior portion of the cap 106 by aligning the vent tube alignment tab 109 with a corresponding groove in the interior of the cap 106. Thus, the vent tube 106 may be fitted into place within the interior of the cap 106, sandwiching the septum 104 between the vent tube 105 and the cap 106. The septum may comprise a silicone based material with a TEFLON layer positioned on an opposite face of the septum 104 with respect to the cap 106 interior. The septum 104 may be held in position through mechanical means (for example, sandwiched between the vent tube 104 and the cap 106), by means of bonding (chemical or otherwise), or a suitable combination of the foregoing. TEFLON is a registered trademark of E. I. du Pont de Nemours and Company in the United States and other countries.

Once assembled, the bottle 100 is ready to be placed into the TOC analyzer, as illustrated for example in FIG. 4. The example TOC analyzer illustrated in FIG. 4 includes four bottle bays (labeled 1-4), however more or fewer bottle bays may be utilized. The bottle 100 is secured into a bottle bay (4) in the illustration of FIG. 4 in an inverted position with an alignment tab 108 oriented towards the user and having an indicator “front” thereon to inform the user of the proper orientation. Furthermore, an embodiment provides that the door of the TOC analyzer may not be closed if a bottle 100 is secured into the bottle bay 101 (1-4) in an incorrect position. In other words, the TOC analyzer may be configured such that the door of the analyzer will close only when the bottle 100 is oriented in the proper position. Again, the bottle 100 may be a standards bottle, a grab sample bottle, or any like bottle, as described herein.

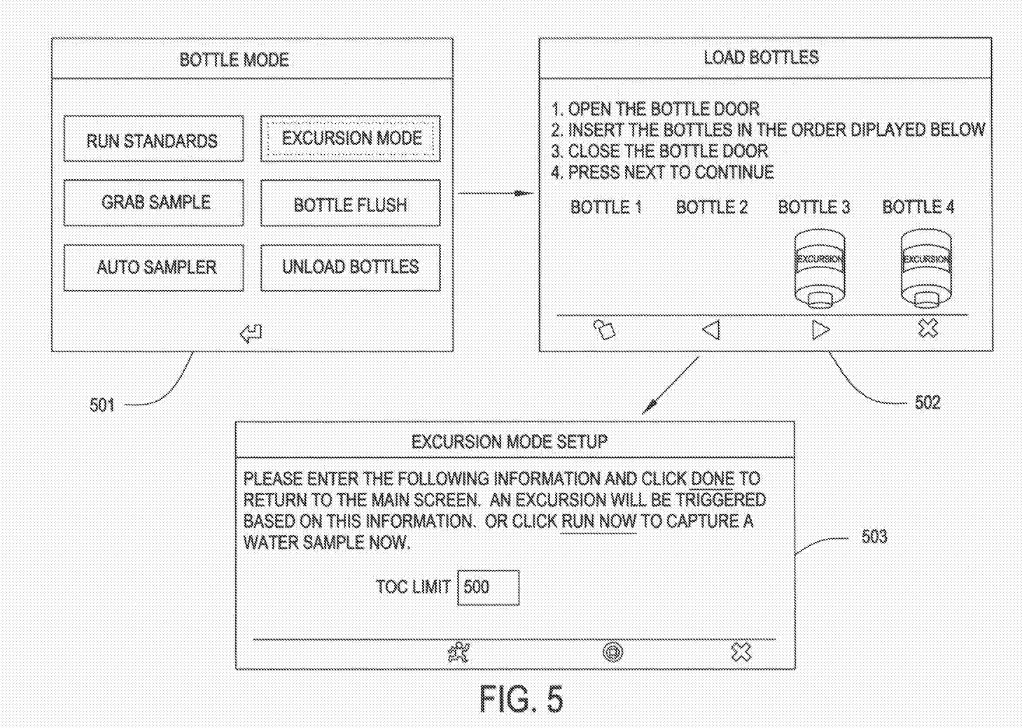

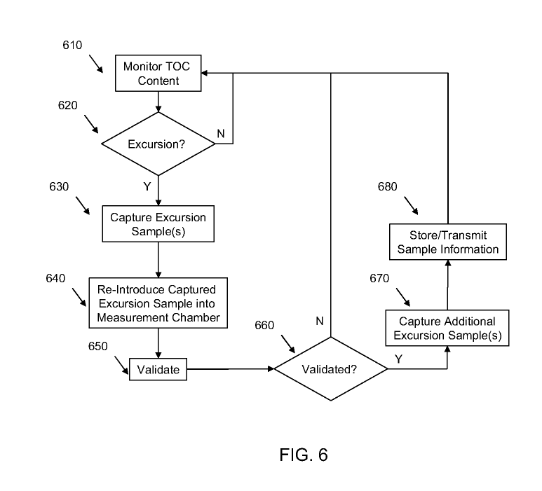

Referring now to FIG. 5 and FIG. 6, an embodiment allows for re-running a captured excursion sample. FIG. 5 illustrates example screen captures from an example user interface, for example a touch screen user interface. The user begins by configuring the analyzer bottle mode and enabling the analyzer to operate in excursion mode by selecting the excursion mode button on a first interface view 501. Next, the analyzer interface provides a view 502 instructing the user to load the excursions bottles in an appropriate bottle bay (bottle bay locations 3 and 4 in this example). Next, the analyzer interface provides a view 503 instructing the user to enter the TOC trigger limit (in appropriate units) in the excursion mode setup dialog box. The analyzer may also store default value(s) or selectable suggested values for known operations. After pressing the run button, an excursion capture will be triggered based on the trigger limit which was set. Thus, the TOC analyzer has been placed in excursion mode and is prepared to automatically capture an excursion sample in an empty excursion bottle, such as bottle 100, placed into the appropriate bottle bays (bottle bays 3 and 4 in the example of FIG. 4).

In excursion mode, the TOC analyzer may automatically capture one or more excursion samples responsive to a detection that a water sample (flowing through the online analyzer via water in and water out lines, FIG. 4) exceeds the specified TOC limit referred to in connection with FIG. 5. FIG. 6 illustrates an example method of automatically capturing and validating excursion samples.

As the TOC analyzer monitors TOC content of the water flowing through the analyzer 610, either continuously or at predetermined intervals, an excursion may be detected 620. That is, a TOC level exceeding a predefined limit, such as dictated by a user, may be detected 620. If a TOC excursion is detected, an embodiment automatically captures one or more sample bottles of water from the analyzer 630. Thus, the analyzer is capable of capturing a relevant sample of water as an excursion sample in an excursion bottle 100 for further analysis of the excursion event initially detected at 620 from the process water. It should be noted that the TOC analyzer may capture more than one excursion sample responsive to detecting an excursion event, such as serially capturing two or more excursion bottles of sample water (for on board analysis or remote/laboratory analysis). A parallel capture of additional samples may also be utilized.

An embodiment may re-introduce the excursion sample captured in the excursion bottle 100 into the analyzer to re-analyze or validate the excursion event 640. Thus, a checking or validation mechanism is enabled. This may be performed automatically or may be the result of a manual input by a user, for example as input via a user interface of the TOC analyzer. The sample may be drawn through fluid transmission needle 102, that is, the same needle as used to collect the excursion sample. As described herein, the vent needle 103 provides adequate venting of gas via provision of vent tube 105 to prevent a vacuum in the bottle during excursion sample collection/capture and during re-introduction of the sample.

The TOC analyzer may reanalyze or validate the excursion sample that has been reintroduced to the analyzer using the same analysis chamber, although this is not a requirement 650. If the sample is validated 660, the analyzer may capture additional bottles 670 for further analysis, and store and/or transmit sample analysis information regarding the excursion sample analyses 680. The sample analysis information may be stored in memory, such as that of the TOC analyzer. Moreover, the sample analysis information may be transmitted to another memory device, such as transmitting the sample analysis information to a remote memory device or transmitting the sample analysis information to a storage unit (for example, an RFID tag) attached to the excursion bottle 100 (for example via a sticker containing the RFID tag). The sample information may include but is not limited to TOC online analysis information (the initial detection of TOC excursion), the validation results, bottle identification, process identification, time stamp, location, and the like.

Thus, with excursion mode enabled and two (or more) empty excursion sample bottles loaded, two samples (for example, 65 ml samples) of the process system water may be drawn immediately, filling both bottles, following the trigger event. Once both bottles have been filled, the instrument may automatically run an excursion sample analysis on the contents of one of the bottles (for example, a bottle in bottle bay 3, following the example of FIG. 5). This analysis thus may be used to validate the online (initial) result. Upon analysis of the contents of the excursion capture bottle, the TOC or conductivity results (sample information) may be reported and if the results are the same or substantially the same, a message stating “excursion is valid” will be reported. If the results are not the same, a message stating indicating that the initial reporting of the excursion event was invalid may be provided.

The water sample in the second bottle (for example, bottle in bottle bay number 4 following the example in FIG. 5) is then available for laboratory/offline analysis to help determine the cause of the water system TOC excursion. Excursion sample bottles may contain an RFID tag or other writable storage or printable indicia. The information from the excursion event is written or printed to the bottle's storage device (for example, RFID tag) or printed to attachable indicia (for example, a sticker) to ensure accurate information about the water sample remains available.

The analyzer may then return to online measurement mode and continues to measure TOC and/or conductivity. Further excursion capture is possible if additional bottles are available in unused bottle bays or if the filled excursion bottles are removed and replaced with new, empty excursion capture bottles.

While the example illustrated in FIG. 1 herein illustrates needles 102, 103 that are substantially similar in length, with the vent needle 103 being somewhat longer, it should be noted that the TOC analyzer according to an embodiment is not limited to this arrangement. As more or fewer bottle bays may be provided than those illustrated in the example of FIG. 5, so too may needles of differing lengths be provided. For example, an embodiment may employ needles such as illustrated in FIG. 2 in certain bottle bays, and needles of differing lengths in other bottle bays. For example, a bottle bay may include a substantially longer vent needle, if desired.

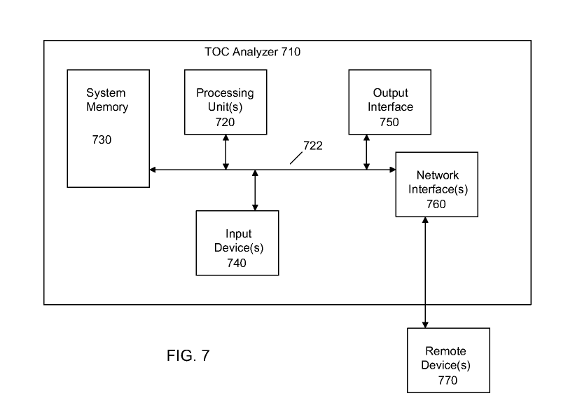

Referring to FIG. 7, it will be readily understood that a TOC analyzer (“analyzer”) 710 may execute program instructions configured to provide automated capturing and testing, as described herein, and perform other functionality of the embodiments.

Components of the analyzer 710 may include, but are not limited to, one or more processing unit(s) 720, a memory 730, and a system bus 722 that couples various components including the memory 730 to the processing unit(s) 720. The analyzer 710 may include or have access to a variety of readable media. The memory 730 may include readable storage media in the form of volatile and/or nonvolatile memory such as read only memory (ROM) and/or random access memory (RAM). By way of example, and not limitation, memory 730 may also include an operating system, application programs, other program modules, and program data.

A user can interface with (for example, enter commands and information) the analyzer 710 through input devices 740. A monitor or other type of device can also be connected to the bus 722 via an interface, such as an output interface 750. In addition to a monitor, analyzers may also include other peripheral output devices. The analyzer 710 may operate in a networked or distributed environment using logical connections to one or more other remote computers or databases. The logical connections may include a network, such local area network (LAN) or a wide area network (WAN), but may also include other networks/buses, including audio channel connections to other devices.

It should be noted as well that certain embodiments may be implemented as a system, method or program product. Accordingly, aspects may take the form of an entirely hardware embodiment, an entirely software embodiment (including firmware, resident software, micro-code, et cetera) or an embodiment combining software and hardware aspects. Furthermore, aspects may take the form of a program product embodied in one or more non-signal readable medium(s) having program code embodied therewith.

A combination of readable mediums may be utilized. The readable medium may be a storage medium. A storage medium may be, for example, but not limited to, an electronic, magnetic, optical, electromagnetic, infrared, or semiconductor system, apparatus, or device, or any suitable combination of the foregoing. Examples (a non-exhaustive list) of the storage medium would include the following: a portable memory device, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a storage medium may be any non-signal medium that can contain or store a program for use by or in connection with an instruction execution system, apparatus, or device such as analyzer 710.

Program code embodied on a computer readable medium may be transmitted using any appropriate medium, including but not limited to wireless, wireline, optical fiber cable, RF, et cetera, or any suitable combination of the foregoing.

Program instructions may also be stored in a storage medium that can direct an analyzer 710 to function in a particular manner, such that the instructions stored in the storage medium produce an article of manufacture including instructions which implement the function/act specified in this description and/or figures.

The program instructions may also be loaded onto the analyzer 710 to cause a series of operational steps to be performed on the analyzer 710 to produce a process such that the instructions which execute on the analyzer 710 provide processes for implementing the functions/acts specified in this description and/or figures.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments have been described herein, it is to be understood that the embodiments are not limited to those precise embodiments, and that various other changes and modifications may be affected therein by one skilled in the art without departing from the scope or spirit of the disclosure.

What is claimed is:

1. A bottle for use with an analyzer, comprising:
a main bottle body; and
a bottle cap attachable to the main bottle body;
the bottle cap comprising:
a main portion having an aperture therein;
a septum sized to cover said aperture and fit within an interior cavity of the bottle cap; and
a vent tube disposed within the interior cavity of the bottle cap.

2. The bottle of claim 1, wherein the vent tube is disposed within the interior cavity of the bottle cap and extends within the main bottle body when the bottle cap is attached to the main bottle body.

3. The bottle of claim 1, wherein the vent tube, the septum and the main portion of the bottle cap are disposed in a layered structure.

4. The bottle of claim 1, wherein the vent tube is hollow.

5. The bottle of claim 1, wherein the bottle cap further comprises one or more grooves in an interior therein matching one or more grooves in the vent tube for aligning the vent tube with respect to a vent needle aperture disposed within the bottle cap.

6. The bottle of claim 1, wherein the bottle cap further comprises one or more alignment tabs.

7. The bottle of claim 6, wherein the one or more alignment tabs are disposed on an exterior surface of the bottle cap.

8. The bottle of claim 7, wherein the one or more alignment tabs are configured to match one or more grooves in a bottle bay of an analyzer.

9. The bottle of claim 8, wherein the analyzer is a total organic carbon analyzer.

10. The bottle of claim 1, further comprising a storage component configured to store sample information transmitted by the analyzer.

11. The bottle of claim 1, wherein the storage component is an RFID tag.

12. A method of validating a measurement of total organic carbon in a sample of water, comprising:
measuring an amount of total organic carbon in a first sample of water using an analyzer and obtaining a first measurement thereof;
identifying a potential excursion event when an amount of total organic carbon in the first sample is above a predefined threshold;
capturing a second sample of water in a bottle responsive to detecting the potential excursion event;
introducing the second sample into a the analyzer;
measuring an amount of total organic carbon in the second sample using the analyzer and obtaining a second measurement thereof; and
comparing the first measurement and second measurement using the analyzer.

13. The method of claim 12, wherein the capturing step is automated by the analyzer.

14. The method of claim 13, wherein the step of measuring an amount of total organic carbon in the first sample of water occurs when the analyzer is in a first mode.

15. The method of claim 14, wherein the step of measuring an amount of total organic carbon in the second sample of water occurs when the analyzer is in the first mode.

16. The method of claim 14, wherein the step of measuring an amount of total organic carbon in the second sample of water occurs when the analyzer is in a second mode.

17. The method of claim 12, further comprising capturing one or more additional samples of water in corresponding one or more additional bottles.

18. The method of claim 17, wherein the one or more additional samples of water are captured in series.

19. The method of claim 17, wherein the one or more additional samples of water are captured in parallel.

20. The method of claim 12, wherein the step of comparing the first measurement and second measurement using the analyzer produces an indication of the comparison.

21. The method of claim 20 further comprising the step of the analyzer providing an indication of the comparison.

22. The method of claim 20, further comprising storing sample information comprising one or more of the first measurement, the second measurement and the indication of the comparison.

23. The method of claim 22, wherein the sample information is stored with the bottle.

24. The method of claim 23, wherein the sample information is stored with the bottle via transmitting the sample information to an RFID tag of the bottle.

25. The method of claim 12, wherein the bottle comprises a vent tube disposed within a bottle cap thereof.

26. An analyzer for validating a measurement of total organic carbon in a sample of water, comprising:
one or more processors; and
a memory storing program instructions executable by the one or more processors, the program instructions comprising:
program instructions for measuring an amount of total organic carbon in a first sample of water using and obtaining a first measurement thereof;
program instructions for identifying a potential excursion event when an amount of total organic carbon in the first sample is above a predefined threshold;
program instructions for capturing a second sample of water in a bottle responsive to detecting the potential excursion event;
program instructions for introducing the second sample into a the analyzer;
program instructions for measuring an amount of total organic carbon in the second sample using the analyzer and obtaining a second measurement thereof; and
program instructions for comparing the first measurement and second measurement.

27. The analyzer of claim 26, wherein the capturing is automated.

28. The analyzer of claim 27, wherein the measuring an amount of total organic carbon in the first sample of water occurs when the analyzer is in a first mode.

29. The analyzer of claim 27, wherein the measuring an amount of total organic carbon in the second sample of water occurs when the analyzer is in the first mode.

30. The analyzer of claim 26, wherein the program instructions further comprise program instructions for capturing one or more additional samples of water in corresponding one or more additional bottles.

31. The analyzer of claim 30, wherein the one or more additional samples of water are captured in series.

32. The analyzer of claim 30, wherein the one or more additional samples of water are captured in parallel.

33. The analyzer of claim 26, wherein further comprising program instructions for producing an indication of the comparison responsive to comparing the first measurement and second measurement.

34. The analyzer of claim 33, further comprising program instructions for providing an indication of the comparison.

35. The analyzer of claim 33, further comprising program instructions for storing sample information comprising one or more of the first measurement, the second measurement and the indication of the comparison.

36. The analyzer of claim 35, wherein the sample information is stored with the bottle.

37. The analyzer of claim 36, further comprising program instructions for transmitting the sample information to an RFID tag of the bottle.

38. A program product for validating a measurement of total organic carbon in a sample of water using an analyzer, comprising:
a computer readable storage medium having program instructions embodied therewith, the program instructions comprising:
program instructions for measuring an amount of total organic carbon in a first sample of water using and obtaining a first measurement thereof;
program instructions for identifying a potential excursion event when an amount of total organic carbon in the first sample is above a predefined threshold;
program instructions for capturing a second sample of water in a bottle responsive to detecting the potential excursion event;
program instructions for introducing the second sample into a the analyzer;
program instructions for measuring an amount of total organic carbon in the second sample using the analyzer and obtaining a second measurement thereof; and
program instructions for comparing the first measurement and second measurement.

39. The program product of claim 38, wherein the capturing is automated.

40. The program product of claim 39, wherein the measuring an amount of total organic carbon in the first sample of water occurs when the analyzer is in a first mode.

41. The program product of claim 39, wherein the measuring an amount of total organic carbon in the second sample of water occurs when the analyzer is in the first mode.

42. The program product of claim 38, wherein the program instructions further comprise program instructions for capturing one or more additional samples of water in corresponding one or more additional bottles.

43. The program product of claim 42, wherein the one or more additional samples of water are captured in series.

44. The program product of claim 42, wherein the one or more additional samples of water are captured in parallel.

45. The program product of claim 38, wherein further comprising program instructions for producing an indication of the comparison responsive to comparing the first measurement and second measurement.

46. The program product of claim 45, further comprising program instructions for providing an indication of the comparison.

47. The program product of claim 38, further comprising program instructions for storing sample information comprising one or more of the first measurement, the second measurement and the indication of the comparison.

48. The program product of claim 47, wherein the sample information is stored with the bottle.

49. The program product of claim 48, further comprising program instructions for transmitting the sample information to an RFID tag of the bottle.
